(19) United States
(12) Patent Application Publication
(10) Pub. No.: US 2008/0069768 A1
(43) Pub. Date: Mar. 20, 2008

(54) Simultaneous production of hydrogen and energy

(76) Inventor: Mohamed Elgafi, Redondo Beach, CA (US)

Correspondence Address: MOHAMED ELGAFI, 1343 S GERTRUDA AVE, REDONDO BEACH, CA, 90277, US

(21) Appl. No.: 11/524,647

(22) Filed: Sep. 20, 2006

(51) Int. Cl. C01B 3/24

(52) U.S. Cl. 423/658.2

(57) ABSTRACT

Hydrogen and energy are simultaneously produced from hydrogen containing matter by predetermined methods.

### CROSS-REFERENCE TO RELATED APPLICATIONS

Not applicable

### FEDERALLY SPONSORED RESEARCH

Not Applicable

### SEQUENCE LISTING OR PROGRAM

Not applicable

### BACKGROUND OF THE INVENTION

1. Field of Invention

This invention relates to hydrogen production and energy recovery from petrochemical and non-petrochemical routes.

2. Prior Art

Hydrogen is produced currently by various major processes, including (1) hydrocarbon processing, which relies on finite resources and foreign suppliers; (2) water splitting, which consumes a lot of energy, more than the energy produced by hydrogen combustion; and (3) biological process, sulfur iodine and acid/metals are limited and not widespread. All current hydrogen technologies are energy intensive. Hydrogen is actually an energy carrier rather than an energy source.

All of the above is thermodynamically inefficient and expensive. The literature is quite voluminous in these technologies. The U.S. government is sponsoring considerable research towards hydrogen economy.

3. Objects and Advantages

The objects and the advantages of the present invention are:
(1) To provide hydrogen and energy simultaneously.
(2) To provide hydrogen and energy from matter containing hydrogen from petrochemical and non-petrochemical source.

### SUMMARY

In accordance with the present invention, hydrogen and energy are simultaneously produced from hydrogen bearing matter by predetermined needs.

### DETAILED DESCRIPTION

Hydrogen bearing matter will release it by predetermined methods. Acetylene, for example, explodes violently when compressed and dissociates to the original constituents.

The energy released from the explosion can be recovered by a predetermined device. Carbon can be separated by mechanical and physical means to reproduce acetylene or to fulfill other needs. Hydrogen may be utilized separately for energy generation or combined with carbon process(s) requirement.

The common gasoline of today and diesel engines of today are based on recovered energy from gasoline and diesel explosions inside combustion chambers.

Acetylene may be produced on site in commercial size facilities or in mobile micro reactors. These energy generation sets may be stationed or mobile.

Acetylene was classically produced from non-oil and gas sources. A new plasma coal based process is developed in China.

I claim:

1) Simultaneous production of hydrogen and energy by precompression of acetylene. Acetylene will dissociate to original constituents, whereby mechanical energy will be produced in addition to the thermal energy content in hydrogen and carbon.

2) The said carbon can be recycled to produce acetylene on site or remote.

3) The said carbon may be utilized for heat and power generation with the hydrogen stream.

4) Simultaneous production of hydrogen and power from hydrogen bearing matter dissociating by compression and predetermined means.
